(19) United States
(12) Patent Application Publication
(10) Pub. No.: US 2015/0281174 A1
(43) Pub. Date: Oct. 1, 2015

(54) METHOD OF TRANSMITTING BY RELAY SERVER FOR ADVANCED DOMAIN NAME SYSTEM

(71) Applicant: National Taipei University of Technology, Taipei City (TW)

(72) Inventors: Shaw Hwa HWANG, Taipei City (TW); Cheng Yu YEH, Taipei City (TW); Kuan Lin CHEN, Taipei City (TW); Yao Hsing CHUNG, Taipei City (TW); Chi Jung HUANG, Taipei City (TW); Li Te SHEN, Taipei City (TW); Shun Chieh CHANG, Taipei City (TW); Bing Chih YAO, Taipei City (TW); Chao Ping CHU, Taipei City (TW); Ning Yun KU, Taipei City (TW); Tzu Hung LIN, Taipei City (TW); Ming Che YEH, Taipei City (TW)

(73) Assignee: National Taipei University of Technology, Taipei City (TW)

(21) Appl. No.: 14/244,377

(22) Filed: Apr. 3, 2014

(30) Foreign Application Priority Data
Mar. 27, 2014 (TW) 103111387

(51) Int. Cl. H04L 29/12; H04L 12/717

(52) U.S. Cl. CPC H04L 61/2589; H04L 45/42

(57) ABSTRACT

The present invention provides an Advanced Domain Name System for implementing method of data transfer between TCP (Transmission Control Protocol) and UDP (User Datagram Protocol) in transport layer for IP protocols in application layer of the Communications Protocol, and also provides a relay server between a PC and a server for transmitting data.

### FIELD OF THE INVENTION

The present invention relates to an Advanced Domain Name System for implementing method of data transfer between TCP (Transmission Control Protocol) and UDP (User Datagram Protocol) in transport layer for IP protocols in application layer of the Communications Protocol, and more particularly to a method of providing a relay server between a PC (personal computer) and a server for transmitting data.

### BACKGROUND OF THE INVENTION

Domain Name System (DNS) is an existing system for converting a domain name into an IP address. As shown in FIG. 1, domain name of PC 1 is UA, domain name of server 2 is UB. If PC 1 wants to connect with server 2, PC1 first inquires DNS server 13 for the corresponding IP address of UB (step 1), DNS server 13 will then respond the IP address of UB to PC 1 (step 2), thereafter PC 1 uses the IP address of UB for connecting with sever 2 (step 3).

Dynamic Domain Name System (DDNS) is also an existing system for converting a domain name into a dynamic IP address. As shown in FIG. 2, domain name of PC 1 is UA, domain name of server 2 is UB, but the IP addresses of both are not fixed. Therefore PC 1 must report to DDNS server 14 regularly the newest IP address thereof (step 1), DDNS server 14 will then acknowledge the newest IP address of PC 1 (step 2). Server 2 must report to DDNS server 14 regularly the newest IP address thereof (step 3), DDNS server 14 will then acknowledge the newest IP address of server 2 (step 4). If PC 1 wants to connect with server 2, first inquires DDNS server 14 for the newest IP address of UB (step 5), DDNS server 14 will then respond the newest IP address of UB to PC 1 (step 6), thereafter PC 1 uses the newest IP address of UB for connecting with sever 2 (step 7).

But if both PC 1 and server 2 are installed with NAT (Network Address Translator) firewall, PC 1 cannot connect with server 2 even if PC 1 acquires the newest IP address of UB of server 2 from DDNS 14.

Communication Protocols have five layers, i.e. physical layer, data link layer, network layer, transport layer and application layer. The present invention relates to transport layer and application layer. In application layer there are HTTP (HyperText Transfer Protocol), RTSP (Real Time Streaming Protocol), SIP (Session Initiation Protocol), etc. In transport layer there are TCP (Transmission Control Protocol) and UDP (User Datagram Protocol), etc. TCP is a reliable channel transmission, while UDP is an unreliable channel transmission. IP protocols like HTTP and RTSP which need reliable channel transmission generally transmit data on TCP. If HTTP and RTSP wants to be transmitted on UDP, a reliable transmitting method must be implemented on UDP.

Referring to FIG. 3, after PC 1 acquires the newest IP address of UB of server 2 and then communicates with server 2 by HTTP, a three-way handshaking has to be conducted first, i.e. PC 1 sends SYN message to an i port of server 2, after the i port of server 2 receives SYN message, returns SYN-ACK message to PC 1, and then PC 1 sends ACK message to i port of server 2 to express the three-way handshaking has finished. Thereafter PC 1 sends HTTP GET packet to server 2, after server 2 receives HTTP GET packet, server 2 will return HTTP 200 OK packet to PC 1 to express that the packet is delivered.

Referring to FIG. 4, if both PC 1 and server 2 are installed with NAT (Network Address Translator) firewall, as shown by NAT firewall 3 and NAT firewall 4 respectively, then NAT firewall 3 and NAT firewall 4 will cause that the three-way handshaking and HTTP communication cannot be conducted between PC 1 and server 2.

### SUMMARY OF THE INVENTION

The object of the present invention is to provide an Advanced Domain Name System for processing data transfer between TCP (Transmission Control Protocol) and UDP (User Datagram Protocol) in transport layer for IP protocols in application layer of the Communications Protocol, and and more particularly to a method of providing a relay server between a PC (personal computer) and a server for transmitting data.

The system of the present invention comprises:

a PC;

a server;

an ADNS server is installed between the PC and the server;

a first NAT firewall is installed between the PC and the ADNS server;

a second NAT firewall is installed between the ADNS server and the server;

a first ADNS module is installed between the PC and the first NAT firewall;

a second ADNS module is installed between the second NAT firewall and the server;

a relay sever is installed between the first NAT firewall and the second NAT firewall;

channels among the first ADNS module, the first NAT firewall, the ADNS server, the relay server, the second NAT firewall and the second ADNS module are UDP channels;

a channel between the PC and the first ADNS module and a channel between the second ADNS module and the server are TCP channels or UDP channels;

The method of the present invention comprises steps of:

a. the PC first sends a Setup message to the first ADNS module to express beginning of data transmitting with the server;

b. thereafter the first ADNS module sends a plurality of Register message to the ADNS server through the first NAT firewall for conducting a plurality of registration;

c. the server provides N communication service ports, and sends a SetServicePort message to the second ADNS module to express a service can be provided; and then the server sends a Setup message to the second ADNS module to express beginning of data transmitting with the PC;

d. thereafter the second ADNS module sends a plurality of Register message to the ADNS server through the second NAT firewall for conducting a plurality of registration;

e. the PC sends a GetInfo message to the first ADNS module to express an intention to get an IP address of a domain name of the server;

f. the first ADNS module sends an Invite message to the ADNS server, the ADNS server returns a Relay IP (IP of the relay server) messge to the first ADNS module to express that an IP of the relay server substitutes for an IP address of domain name of the server;

g. the ADNS server sends Invite message and Relay IP message to the second ADNS module to express to the server that IP of the relay server substitutes for an IP address of domain name of the PC;

h. each of the first ADNS module and the second ADNS module sends a Peer message to the relay server to express achieving the first NAT firewall and the second NAT firewall traversing;

i. the relay server sends Peer OK message to both the first ADNS module and the second ADNS module to express that the relay server can transmit data for the PC and the server;

j. the first ADNS module sends a Get message to the relay server, the relay server sends the Get message to the second ADNS module in order to get N communication service ports of the server;

k. the second ADNS module provides N communication service ports of the server to the relay server, and then to the first ADNS module by the relay server so that the first ADNS module will also open N communication service ports correspondingly;

l. the first ADNS module sends a Give Local IP message to the PC to pretend that the IP of domain name of the server is a local IP;

m. the PC conducts a three-way-handshaking with the first ADNS module, then the first ADNS module sends a Notify connect message to the relay server, and then to the second ADNS module by the relay server to enable the second ADNS module and the server to perform a three-way-handshaking;

n. the second ADNS module sends a Notify FINE message to the relay server, and then to the first ADNS module by the relay server to express that everything is ready for accepting packets;

o. the PC sends an IP GET packet to the first ADNS module for being hold by the first ADNS module;

p. the first ADNS module sends the IP GET packet to the relay server, the relay server sends the IP GET packet to the second ADNS module;

q. the second ADNS module sends the IP GET packet to the server;

r. the server returns an IP 200 OK packet to the second ADNS module;

s. the second ADNS module sends the IP 200 OK packet to the relay server, the relay server sends the IP 200 OK packet to the first ADNS module;

t. the first ADNS module sends the IP 200 OK packet to the PC to express that the IP packet is delivered.

The aforementioned step o and step r have to conduct a conversion as stated below:

Data transferred from TCP channel (such as IP GET packet, IP 200 OK packet) are sent to a first numbering header for assigning an identifying number header to the data, and then sent to a UDT Library, the UDT Library will add a UDT header to the data transferred from TCP channel, and let the data transfer through UDP channel by a reliable mechanism of UDT;

data transferred from UDP channel are sent to a second numbering header for assigning an identifying number header to the data, and then sent to UDP channel directly.

The aforementioned step q and step t have to conduct a conversion as stated below:

Data transferred from UDP channel (such as IP GET packet, IP 200 OK packet) are determined if it is a UDT packet, If the data has a UDT header, then it is a UDT packet, so the packet is sent to the UDT Library to delete the UDT header, and sent to the first numbering header to delete the identifying number header, then sent through a corresponding TCP channel according to the identifying number;

if the data has no UDT header, then it is a UDP packet, so the packet is sent to the second numbering header to delete the identifying number header, and then sent to a corresponding UDP channel according to the identifying number.

The aforementioned UDT Library can be downloaded from http://udt.sourceforge.net/software.html.

### BRIEF DESCRIPTION OF THE DRAWINGS

FIG. 1 shows schematically a domain name system.

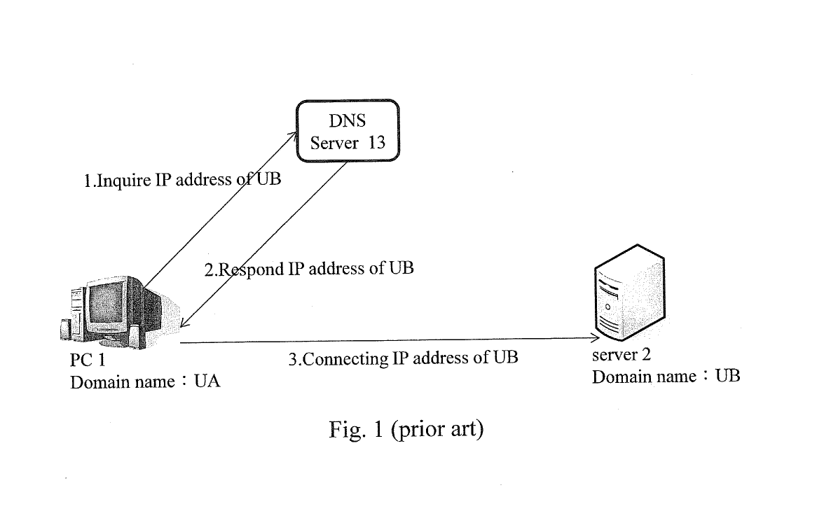

FIG. 2 shows schematically a dynamic domain name system.

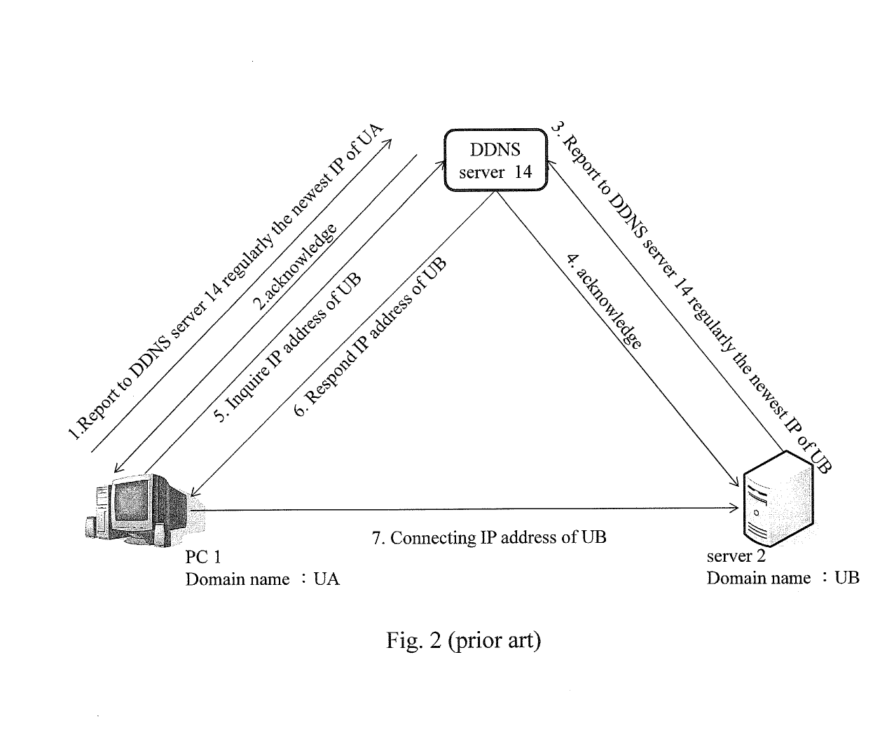

FIG. 3 shows schematically a three-way handshaking and an HTTP communication between a PC and a server.

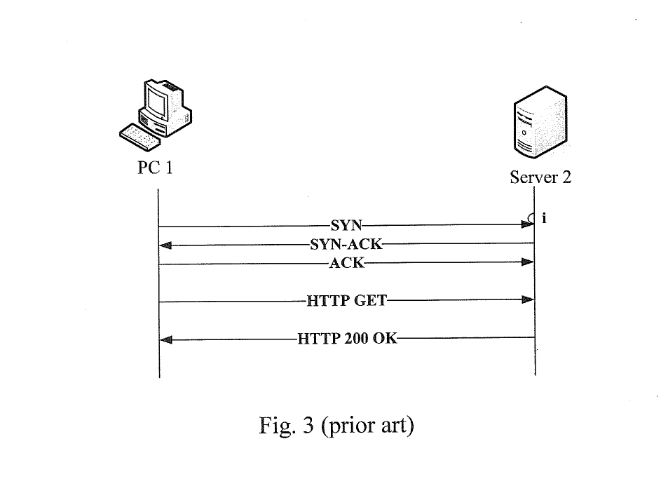

FIG. 4 shows schematically NAT firewalls are installed between the PC and the server.

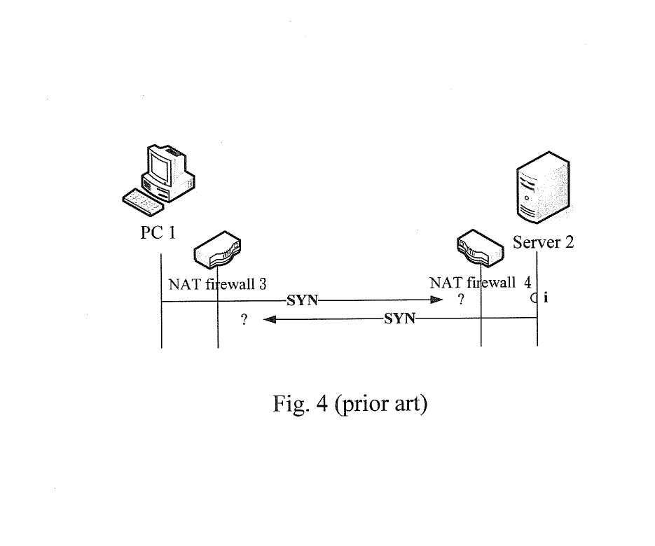

FIG. 5 shows schematically a relay server and NAT firewalls are installed in an advanced domain name system for transmitting data according to the present invention.

FIG. 6 shows schematically an embodiment according to the present invention.

FIG. 7 shows continuously the embodiment according to the present invention.

FIG. 8 shows schematically a transmission between UDP channel and UDP channel.

FIG. 9 shows schematically the converting processes from TCP channel or UDP channel to UDP channel.

FIG. 10 shows schematically the converting processes from UDP channel to TCP channel or UDP channel.

### DETAILED DESCRIPTIONS OF THE PREFERRED EMBODIMENTS

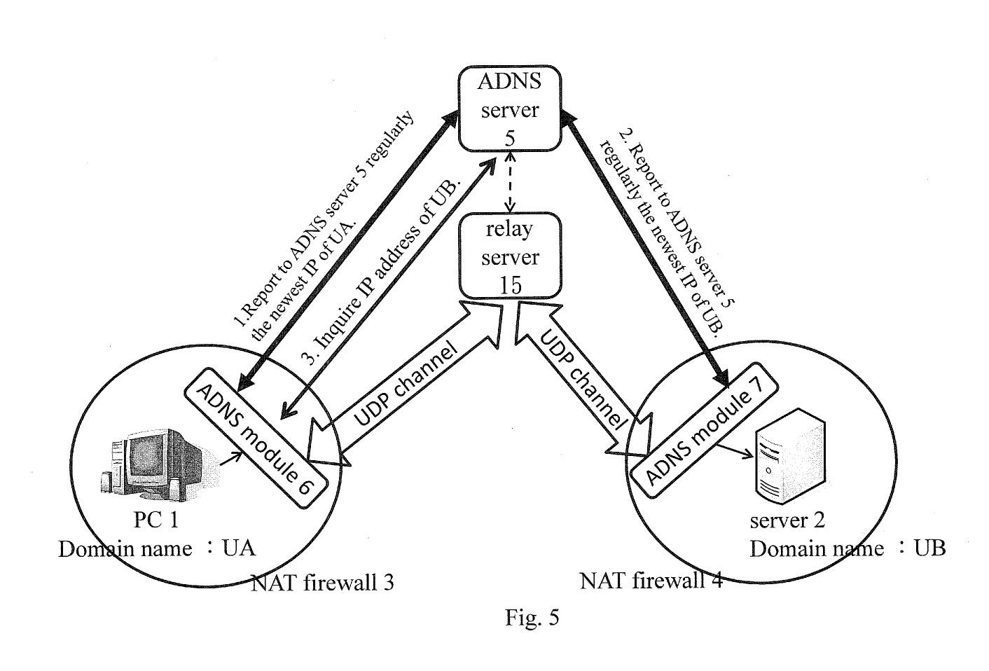

Referring to FIG. 5, which shows schematically NAT firewalls and a relay server are installed in an advanced domain name system for transmitting data according to the present invention. PC1 and server 2 are installed with NAT firewall 3 and NAT firewall 4 respectively. PC1 and server 2 must report to ADNS server 5 regularly the newest IP addresses of domain name UA and UB thereof (step 1 and step 2). When PC 1 wants to connect with server 2, first inquires ADNS server 5 for the newest IP address of UB (step 3), and then transmits data through ADNS module 6, relay server 15, ADNS module 6 to sever 2.

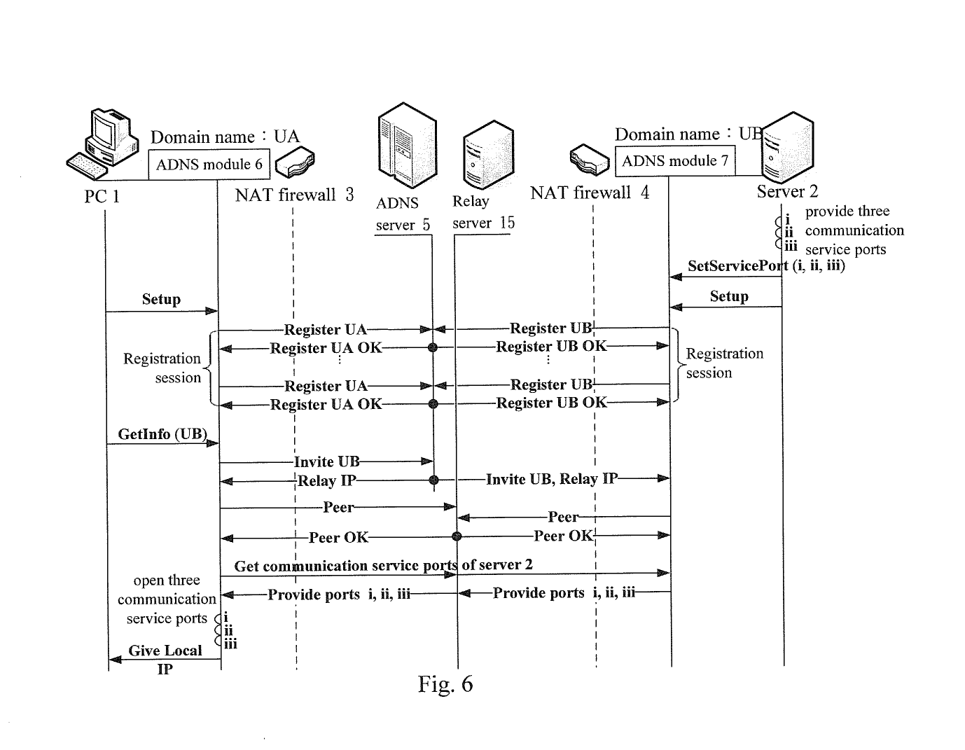

Referring to FIG. 6, PC1 and server 2 are installed with NAT firewall 3 and NAT firewall 4 respectively, an ADNS (Advanced Domain Name System) server 5 and a relay server 15 are installed between NAT firewall 3 and NAT firewall 4, an ADNS module 6 is installed between PC 1 and NAT firewall 3, an ADNS module 7 is installed between NAT firewall 4 and server 2. ANDS module 6 and ANDS module 7 are software programs and are installed in PC 1 and server 2 respectively for solving the NAT firewall traversal problems with ADNS server 5 and relay server 15, and for managing the converting processes of IP protocols like HTTP, RTSP and SIP between TCP and UDP.

In FIG. 6, the channels among ADNS module 6, NAT firewall 3, ADNS server 5, relay server 15, NAT firewall 4 and ADNS module 7 are UDP channels, while the channel between PC 1 and ADNS module 6 and the channel between ADNS 7 and server 2 are TCP channels.

Referring to FIG. 6, domain name of ADNS module 6 is the domain name UA of PC 1, domain name of ADNS module 7 is the domain name UB of server 2. PC 1 first sends a Setup message to ADNS module 6 to express beginning of transmitting data with server 2, thereafter ADNS module 6 sends a Register UA message to ADNS server 5 through NAT firewall 3, then ADNS server 5 returns a Register UA OK message to ADNS module 6 through NAT firewall 3. The registrations are conducted for several times (step 1 in FIG. 5).

Concurrently, server 2 provides three communication service ports i, ii, iii, and sends a SetServicePort (i, iii) message to ADNS module 7 to express a service can be provided. Server 2 will then sends a Setup message to ADNS module 7 to express beginning of transmitting data with PC1, thereafter ADNS module 7 sends a Register UB message to ADNS server 5 through NAT firewall 4, then ADNS server 5 returns a Register UB OK message to ADNS module 7 throughNAT firewall 4. The registrations are conducted for several times (step 2 in FIG. 5).

Thereafter PC 1 sends a GetInfo (UB) message to ADNS module 6 to express the intention to get the IP address of UB of server 2. ADNS module 6 sends Invite UB message to ADNS server 5 through NAT firewall 3. ADNS server 5 returns a Relay IP message to ADNS module 6 (step 3 in FIG. 5). Relay IP is the IP of relay server 15, and is used to substitute the IP of UB of server 2.

ADNS server 5 sends Invite UB message and Relay IP message to ADNS module 7, expresses to server 2 that the IP of relay server 15 is used to substitute the IP of UA of PC 1.

Both ADNS module 6 and ADNS module 7 send Peer message to relay server 15 expressing that traversing NAT firewall 3 and NAT firewall 4 can be achieved. Relay server 15 will then sends Peer OK message to both ADNS module 6 and ADNS module 7, expressing that data transmitting can be done for PC 1 and server 2.

ADNS module 6 sends a Get message to relay server 15 to express the intention to get communication service ports of server 2, relay server 15 send Get message to ADNS module 7. ADNS module 7 will then provides three communication service ports i, iii of the server 2 to relay server 15, and then to ADNS module 6 by relay server 15, so that ADNS module 6 will also open three communication service ports i, ii, iii correspondingly. ADNS module 6 sends a Give Local IP message to PC 1 to pretend that the IP address of UB of server 2 is a local IP.

At this time, the UDP channel between ADNS module 6 and ADNS module 7 has been getting through by relay server 15. The channel between PC 1 and ADNS module 6 as well as the channel between ADNS module 7 and server 2 are TCP channels.

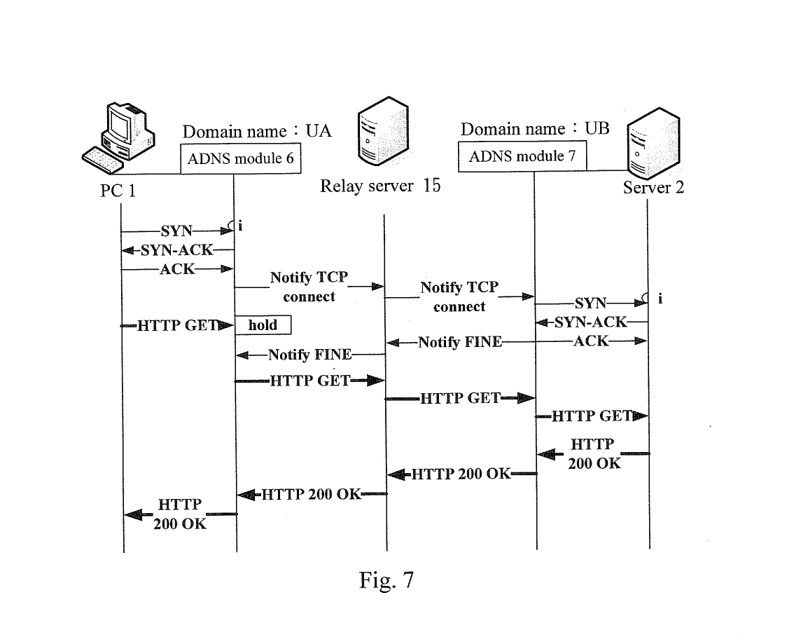

Continuously referring to FIG. 7, PC1 conducts three-way-handshaking with ADNS module 6 according to the pretended local IP address. PC1 first sends SYN message to i port of ADNS module 6, then i port of ADNS module 6 returns SYN-ACK message to PC 1, finally PC1 sends ACK message to i port of ADNS module 6 for achieving three-way-handshaking.

Thereafter i port of ADNS module 6 sends Notify TCP connect message to relay server 15, relay server 15 sends Notify TCP connect message to ADNS module 7 to enable ADNS module 7 and i port of server 2 to perform three-way-handshaking.

ADNS module 7 first sends SYN message to i port of server 2, then i port of server 2 returns SYN-ACK message to ADNS module 7, finally ADNS module 7 sends ACK message to i port of server 2 for achieving three-way-handshaking.

After ADNS module 7 and server 2 finish three-way-handshaking, ADNS module 7 sends Notify FINE message to relay server 15, relay server 15 sends Notify FINE message to i port of ADNS module 6 to express that everything is ready for accepting packets.

PC 1 sends HTTP GET packet to i port of ADNS module 6 for being hold by i port of ADNS module 6.

Thereafter i port of ADNS module 6 sends HTTP GET packet to relay server 15, relay 15 sends HTTP GET packet to ADNS module 7, and then ADNS module 7 sends HTTP GET packet to i port of server 2.

The i port Server 2 returns HTTP 200 OK packet to ADNS module 7, and then ADNS module 7 sends HTTP 200 OK packet to relay server 15, relay server 15 send HTTP 200 OK packet to i port of ADNS module 6, thereafter ADNS module 6 sends HTTP 200 OK packet to PC 1 to express that HTTP packet is delivered.

The three communication service ports i, ii, iii of server 2 is for example only, actually it is not limited to three ports. The aforementioned HTTP is also for example only, other IP protocols like RTSP, SIP can also be used, and HTTP GET changes into IP GET, HTTP 200 OK changes into IP 200 OK.

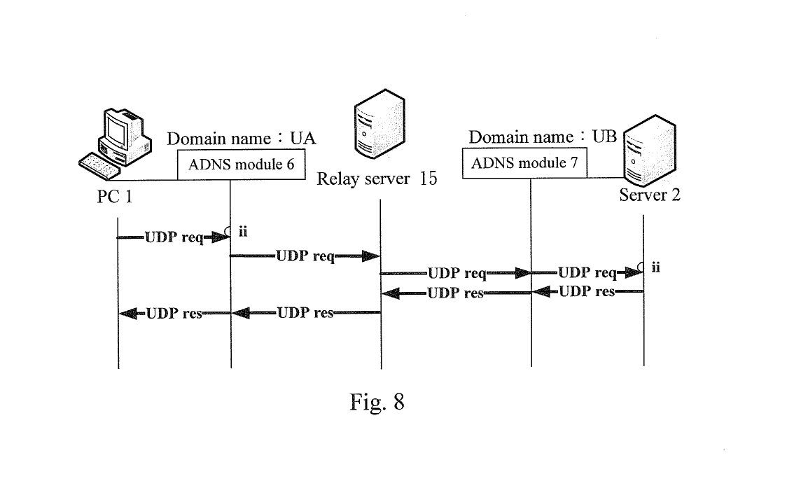

If the channel between PC1 and ADNS module 6, the channel between ADNS module 6, relay server 15 and ADNS module 7, and the channel between ADNS module 7 and server 2 are all UDP channels (for example SIP protocol), then as shown in FIG. 8, PC1 sends UDG_{req} packet to ii port of ADNS module 6, passes through relay server 15 and ADNS module 7, and finally reachs ii port of server 2. The ii port of server 2 returns UDPᵣₑₛ Packet to ADNS module 7, passes through relay server 15 and ADNS module 6, and finally reach PC 1 to express the packet is delivered. Conversions have to be conducted in ADNS module 6 and ADNS module 7.

HTTP GET packet from PC 1 to i port of ADNS module 6 is by way of TCP channel, but HTTP GET packet from ADNS module 6 to relay server 15 is by way of UDP channel, so a conversion has to be conducted in ADNS module 6. Similarly, HTTP 200 OK packet from i port of server 2 to ADNS module 7 is by way of TCP channel, but HTTP 200 OK packet from ADNS module 7 to relay server 15 is by way of UDP channel, so a conversion has to be conducted in ADNS module 7.

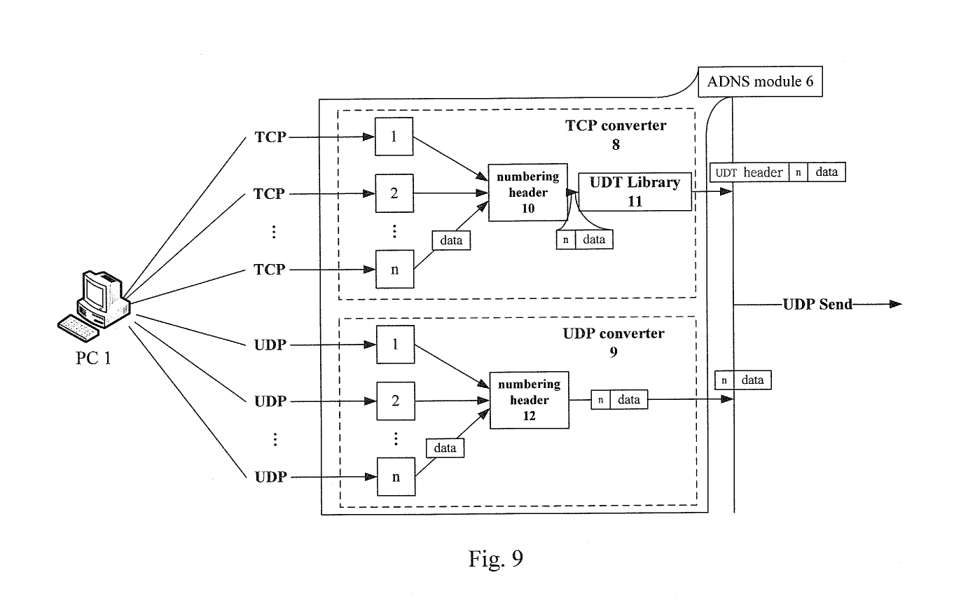

Referring to TCP converter 8 and UDP converter 9 in FIG. 9, a conversion from TCP channel or UDP channel to UDP channel in ADNS module 6 is described. Suppose that PC 1 has n TCP channels and n UDP channels.

Data transferred from TCP channel are sent to numbering header 10 for assigning an identifying number header n to the data, and then sent to UDT Library 11. UDT means “UDP-based Data Transfer Protocol”, which is an algorithm for implementing reliable data transfer on UDP channel. UDT Library 11 will add UDT header to the data transferred from TCP channel, and let the data transfer through UDP channel by a reliable mechanism of UDT, as shown by “UDP Send”. UDT Library 11 can be downloaded from http://udt.sourceforge.net/software.html.

Data transferred from UDP channel are sent to numbering header 12 for assigning an identifying number header n to the data, and then sent to UDP channel directly, as shown by “UDP Send”.

The aforementioned HTTP GET packet from i port of ADNS module 6 to relay server 15 and then to ADNS module 7 is by way of UDP channel, but HTTP GET packet from ADNS module 7 to i port of server 2 is by way of TCP channel, a conversion has to be conducted. Similarly, HTTP 200 OK packet from ADNS module 7 to relay server 15 and then to i port of ADNS module 6 is by way of UDP channel, but HTTP 200 OK packet from ADNS module 6 to PC 1 is by way of TCP channel, a conversion has also to be conducted.

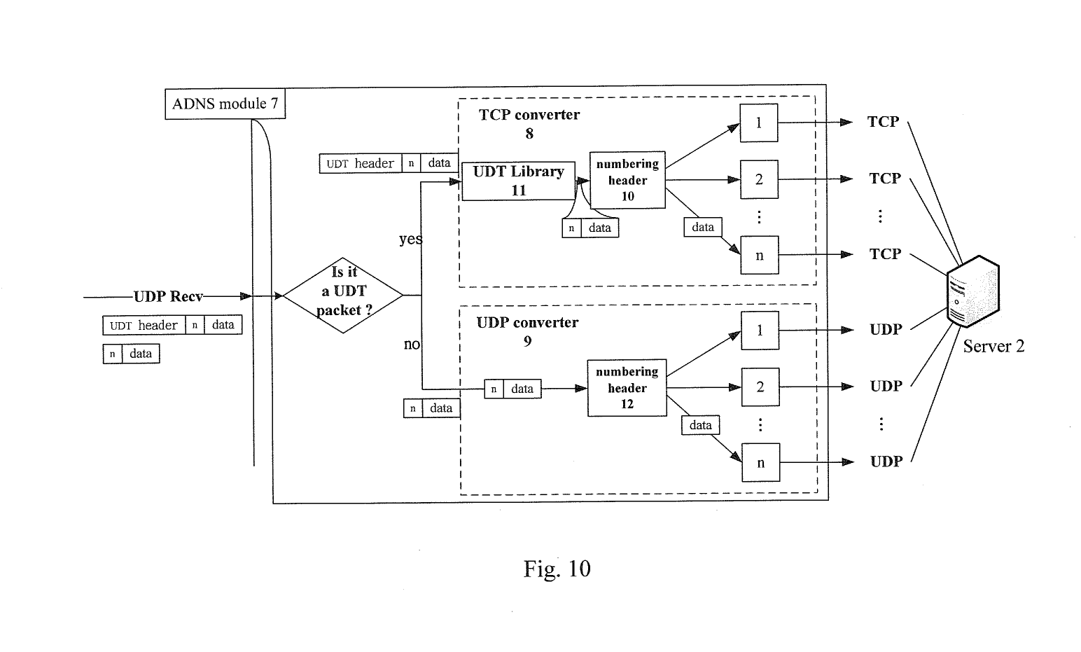

Referring to TCP converter 8 and UDP converter 9 in FIG. 10, a reverse conversion from UDP channel to TCP channel or UDP channel in ADNS module 7 is described. “UDP Recv” means that ADNS module 7 receives a packet. A decision is made to determine if it is a UDT packet. If the packet has a UDT header, then it is a UDT packet, so the packet is sent to UDT Library 11 to delete the UDT header, and sent to numbering header 10 to delete the identifying number header n, and then sent through a corresponding TCP channel to server 2 according to the identifying number. If the packet has no UDT header, then it is a UDP packet, so the packet is sent to numbering header 12 to delete the identifying number header n, and then sent through a corresponding UDP channel to server 2 according to the identifying number.

The jobs in FIG. 9 and FIG. 10 can be done by both ADNS module 6 and ADNS module 7.

The scope of the present invention depends upon the following claims, and is not limited by the above embodiments.

What is claimed is:

1. A method of transmitting by relay server for advanced domain name system, comprising:
a PC;
a server;
an ADNS server is installed between the PC and the server;
a first NAT firewall is installed between the PC and the ADNS server;
a second NAT firewall is installed between the ADNS server and the server;
a first ADNS module is installed between the PC and the first NAT firewall;
a second ADNS module is installed between the second NAT firewall and the server;
a relay sever is installed between the first NAT firewall and the second NAT firewall;
channels among the first ADNS module, the first NAT firewall, the ADNS server, the relay server, the second NAT firewall and the second ADNS module are UDP channels;
a channel between the PC and the first ADNS module and a channel between the second ADNS module and the server are TCP channels or UDP channels;
said method comprising steps of:
a. the PC first sends a Setup message to the first ADNS module to express beginning of data transmitting with the server;
b. thereafter the first ADNS module sends a plurality of Register message to the ADNS server through the first NAT firewall for conducting a plurality of registration;
c. the server provides N communication service ports, and sends a SetServicePort message to the second ADNS module to express a service can be provided; and then the server sends a Setup message to the second ADNS module to express beginning of data transmitting with the PC;
d. thereafter the second ADNS module sends a plurality of Register message to the ADNS server through the second NAT firewall for conducting a plurality of registration;
e. the PC sends a GetInfo message to the first ADNS module to express an intention to get an IP address of a domain name of the server;
f. the first ADNS module sends an Invite message to the ADNS server, the ADNS server returns a Relay IP (IP of the relay server) messge to the first ADNS module to express that an IP of the relay server substitutes for an IP address of domain name of the server;
g. the ADNS server sends Invite message and Relay IP message to the second ADNS module to express to the server that IP of the relay server substitutes for an IP address of domain name of the PC;
h. each of the first ADNS module and the second ADNS module sends a Peer message to the relay server to express achieving the first NAT firewall and the second NAT firewall traversing;
i. the relay server sends Peer OK message to both the first ADNS module and the second ADNS module to express that the relay server can transmit data for the PC and the server;
j. the first ADNS module sends a Get message to the relay server, the relay server sends the Get message to the second ADNS module in order to get N communication service ports of the server;
k. the second ADNS module provides N communication service ports of the server to the relay server, and then to the first ADNS module by the relay server so that the first ADNS module will also open N communication service ports correspondingly;
l. the first ADNS module sends a Give Local IP message to the PC to pretend that the IP of domain name of the server is a local IP;
m. the PC conducts a three-way-handshaking with the first ADNS module, then the first ADNS module sends a Notify connect message to the relay server, and then to the second ADNS module by the relay server to enable the second ADNS module and the server to perform a three-way-handshaking;
n. the second ADNS module sends a Notify FINE message to the relay server, and then to the first ADNS module by the relay server to express that everything is ready for accepting packets;
o. the PC sends an IP GET packet to the first ADNS module for being hold by the first ADNS module;
p. the first ADNS module sends the IP GET packet to the relay server, the relay server sends the IP GET packet to the second ADNS module;
q. the second ADNS module sends the IP GET packet to the server;
r. the server returns an IP 200 OK packet to the second ADNS module;
s. the second ADNS module sends the IP 200 OK packet to the relay server, the relay server sends the IP 200 OK packet to the first ADNS module;
t. the first ADNS module sends the IP 200 OK packet to the PC to express that the IP packet is delivered;
wherein the step o and the step r have to conduct a conversion as stated below:
data transferred from TCP channel (such as IP GET packet, IP 200 OK packet) are sent to a first numbering header for assigning an identifying number header to the data, and then sent to a UDT Library, the UDT Library will add a UDT header to the data transferred from TCP channel, and let the data transfer through UDP channel by a reliable mechanism of UDT;
data transferred from UDP channel are sent to a second numbering header for assigning an identifying number header to the data, and then sent to UDP channel directly;
wherein the step q and the step t have to conduct a conversion as stated below:
data transferred from UDP channel (such as IP GET packet, IP 200 OK packet) are determined if it is a UDT packet, If the data has a UDT header, then it is a UDT packet, so the packet is sent to the UDT Library to delete the UDT header, and sent to the first numbering header to delete the identifying number header, then sent through a corresponding TCP channel according to the identifying number;
if the data has no UDT header, then it is a UDP packet, so the packet is sent to the second numbering header to delete the identifying number header, and then sent to a corresponding UDP channel according to the identifying number.

2. The method of transmitting by relay server for advanced domain name system according to claim 1, wherein the UDT Library can be downloaded from http://udt.sourceforge.net/software.html.
